(19) United States
(12) Patent Application Publication
(10) Pub. No.: US 2004/0246199 A1
(43) Pub. Date: Dec. 9, 2004

(54) Three-dimensional viewing apparatus and method

(76) Inventor: Artoun Ramian, Marbella (ES)

Correspondence Address: Law Office of William B. Ritchie, 43 Jackson Street, Concord, NH, 03301, US

(21) Appl. No.: 10/784,471

(22) Filed: Feb. 23, 2004

Related U.S. Application Data
(60) Provisional application No. 60/449,365, filed on Feb. 21, 2003.

(51) Int. Cl. G09G 5/00

(52) U.S. Cl. 345/6

(57) ABSTRACT

A three-dimensional image for a set viewpoint wherein a user can control the viewpoint, effectively rotating the displayed image around at least the Y-axis. By tracking the position of the user and altering the viewpoint of the projected image, the image can be automatically rotated to suit the user's viewing position. The soundscape can also be altered to match the currently displayed viewpoint. The viewpoint can be controlled by the user, who is effectively able to “explore” the moving image. To provide a three-dimensional display environment, the invention utilizes at least two stacked display layers, enabled by using stacked Transparent Organic Light Emitting Devices (TOLEDS), which are well known in the art. Color TOLED technology is itself stacked display technology, having multiple layers, each of a differing color, namely cyan, magenta, yellow and black or red, green and blue. In TOLED technology the layers are bound so close together, that as they are lit with differing layers being on and off, and each having a separate intensity, it is possible to reproduce pixels having a wide range of color variation. As TOLEDs contain pixels, which in their non-illuminated state are transparent, it is a simple matter to have stacked TOLED's where the front layer contains transparent areas which allow details on subsequent layers to shine through to the user. The invention stacks the TOLEDs close together, but not necessarily absolutely adjacent, so that pixels from a scene can be spread among the several layers of stacked displays, which provides a greater sense of visual depth within the scene.

This application claims benefit of priority under 35 U.S.C. §119(e) to U.S. Provisional Application Ser. No. 60/449,365, filed on Feb. 21, 2003.

### BACKGROUND OF INVENTION

1. Field of the Invention

The present invention relates to visual display units (VDUs), specifically, a VDU enabling a user to view images which provide a sense of natural depth to the user.

2. Description of the Related Art

Three dimensional projection systems have been around for many years and have utilized four distinct techniques.

The first is a method of having a pair of glasses which place one color of film, for example red, over the left eye and another color, for example blue, over the right eye, then, a projection system superimposes two images, of the same information, but having two distinct colors, one color being visible mainly to the left eye and the other being mainly visible to the right eye. The first method, despite having images which are superimposed, effectively provides two subtly different points of view for the same scene, with one of each of the points of view relating to the left or right eye.

The second method is very similar to the first method, but rather than using colored films in front of the eyes it utilizes polarized filters, thus, the left eye would be able to see light in the vertical polarization and the right eye would be able to see light in the horizontal polarization. Once again, the second method has images, which although superimposed, are detectable distinctly to the left or right eye separately.

The third method again utilizes spectacles where the lenses are constructed from what are commonly referred to as LCD shutters. Each lens is clear until a voltage change effects a change in the opacity of a specific lens, left or right. It is possible for a computer system to have the left, right, or both lenses opaque or transparent, which, when synchronized with a visual display unit, causes the display to render an image targeted at the left eye, when the left lens is transparent, then rapidly changes to an imaged targeted at the right eye, when the left lens then changes to an opaque state and the right lens becomes transparent. It can therefore be seen why the third method is referred to as shutters, as each eye is effectively opened and closed, in substantially perfect synchronization with an image which alternates, again, between two point of view.

The fourth method is commonly used for Virtual Reality environments, and is often referred to as a Head Mounted Display (HMD). The HMD has a VDU for each eye, mounted as glasses or as part of a helmet construction. The left display projects an image of the left point of view, for the left eye, and of course, the right display projects an image of the right point of view for the right eye.

All of the four devices thus described achieve a feeling of three dimensions, as they cater for the sense of perspective, required to make a displayed object feel as though it possesses depth. Depth is the key component any image projection or rendering system requires in order to make the user more likely to believe that they are viewing a real life object. This in turn leads to the common phrase, “having a more immersive experience”, i.e. the user feels more part of the world, or space, in which the displayed object, or objects, exist.

The most immersive experience by far, comes from HMD devices, as they are often a component in a much greater device, used to produce a virtual environment. HMDs are therefore part of a more cumbersome device and not readily usable in most commercial or domestic environments. Furthermore, HMDs are designed for use by one person at a time, and are not, therefore, suitable for shared experiences.

The three devices which utilize spectacles, namely colored film, polarized filters or LCD shutters, can be utilized by one person or entire audiences in a theatre. However, the viewpoint, which is projected, is shared by all viewers. If an individual viewer was to move around in the theatre they would not be able to see anything that the other viewers, who had not moved, could not see themselves. As a subtle example, if a character stands in front of another character in a scene, and the viewer was to lean to the left or right, they would not be able to see any more of the character, furthest away from the viewer. This obviates the fact that the viewer can not change their viewpoint by changing their viewing position, nor, can they alter the projected image in anyway.

Therefore a method of producing a three-dimensional image, which can be viewed by multiple users from a single yet changeable viewpoint, is not found in the current art.

### SUMMARY OF THE PRESENT INVENTION

It is an aspect of the present invention to provide a means of displaying a three-dimensional image for a set viewpoint. A user can control the viewpoint, effectively rotating the displayed image around at least the Y-axis. By tracking the position of the user and altering the viewpoint of the projected image, the image can be automatically rotated to suit the user's viewing position. The soundscape can also be altered to match the currently displayed viewpoint.

A method of displaying a moving image is provided. The viewpoint can be controlled by the user, who is effectively able to “explore” the moving image. Explore is defined to mean the act of changing the viewpoint over a three-dimensional scene, by way of a user interface, which enables the user to see an image as if they had stood in one of a plurality of preset positions, while the image was being recorded. Viewpoint is defined to mean one of a number of preset positions.

Many DVD movie presentations contain scenes where the viewer can select a viewing angle, from among several possible viewing angles. In order to provide this feature, the film creators have employed several cameras to record the same scene. The viewer can then select any of the cameras as their point of view, so they are able to watch the same scene from several viewpoints, thus, revealing more detail about the scene and its environment.

In the simplest embodiment of the invention, referred to as Visual Display Unit with Depth (VDUD), the user sits in front of the VDUD and is presented with a single viewpoint, selected from among several viewpoints. The viewpoint appears to have greater depth than prior art methods as several display units are stacked, one in front of another, giving several display layers, and effectively providing a more natural feeling of depth.

Another embodiment of the invention, referred to as Visual Display Unit 3D (VDU3D), enables the user to circle around the invention, wherein the invention senses the user's position and selects the closest matching preset viewpoint to the users physical position, as though the user had walked around outside of the actual scene being rendered.

In order to provide a three-dimensional display environment, the invention utilizes at least two stacked display layers, enabled by using stacked Transparent Organic Light Emitting Devices (TOLEDS), which are well known in the art. Color TOLED technology is itself stacked display technology, having multiple layers, each of a differing color, namely cyan, magenta, yellow and black or red, green and blue. In TOLED technology the layers are bound so close together, that as they are lit with differing layers being on and off, and each having a separate intensity, it is possible to reproduce pixels having a wide range of color variation. As TOLEDs contain pixels, which in their non-illuminated, are transparent, it is a simple matter to have stacked TOLED's where the front layer contains transparent areas which allow details on subsequent layers to shine through to the user.

The invention stacks the TOLEDs close together, but not necessarily absolutely adjacent, so that pixels from a scene can be spread among the several layers of stacked displays, which provides a greater sense of visual depth within the scene.

While TOLEDs are transparent, it is recognized that a certain amount of light absorption occurs; where light from a backmost TOLED is absorbed by those TOLEDs occurring in front of it.

However, as TOLED technology develops, or alternative enabling display technologies emerge, the optical clarity of pixels in the off state will increase, and, therefore, overall transparency will correspondingly increase. This will lead to the invention having the ability to include a greater and greater number of layers, increasing the depth of the three-dimensional image being displayed.

Other aspects, features and advantages of the invention will become obvious from the following detailed description that is given for one embodiment of the invention while referring to the accompanying drawings.

### BRIEF DESCRIPTION OF THE DRAWINGS

FIG. 1 is an illustration of the 3D viewing apparatus in accordance with the invention.

FIG. 2 is an illustration of the main components included in the base unit.

FIG. 3 is an illustration of one embodiment of the 3D viewing apparatus.

FIG. 4 is a detailed illustration showing pixels relating to a single character that are distributed across several display layers to increase the sense of visual depth.

FIG. 5 is a detailed illustration showing a three-dimensional matrix of cubic pixels to create an image display system that can be viewed from virtually any angle.

FIG. 6 is an illustration showing a user in an exemplary position wherein the 3D viewing apparatus senses the position of the user and adjusts sound, emitted from several speakers, to suit the position of the user.

### DETAILED DESCRIPTION OF THE INVENTION

The invention is a visual display unit dedicated to the reproduction of three-dimensional images of a simple or complex nature.

Prior art, such as televisions, LCD flat panels and the like, while being extremely popular and robust technologies, do not meet the needs of those users requiring true three-dimensional viewing, or viewing which possesses a greater sense of natural depth. Many alternative methods of answering this need have been proposed as noted above.

The invention is conceptually similar to having many televisions stacked one in front of the other, but where information is not displayed on the front most screen, information is permitted to show through from screens which are further back in the stack.

By using this approach, displaying a face across three layers, would display pixels to represent the nose on the front most screen, pixels to represent the cheeks and eyes on a middle screen, and pixels to represent the ears on the back most screen. This provides a sense of depth unparalleled with prior art methods and devices.

By utilizing thin display technology, such as the aforementioned TOLEDs, the 3D viewing apparatus can have many, multiple layers across which pixels from a scene can be distributed.

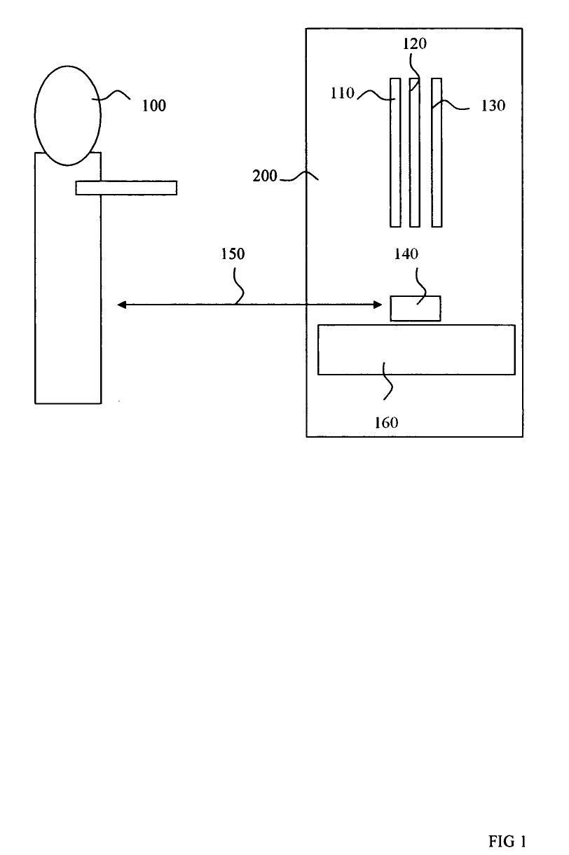

As shown in FIG. 1, user 100 is in position relative to three-dimensional viewer (TDV) 200. Each viewing layer 110, 120 and 130 is a TOLED or similar display technology. At least two viewing layers are required to provide a sense of depth, by distributing pixels from any moving image across several stacked displays.

Sensor 140 is utilized by TDV 200 to sense the position of user 100. User 100, utilizing a many layered embodiment of the invention, can move around TDV 200 thereby making changes in the viewing position. Sensor 140 can be enabled by the inclusion of at least one ultrasonic emitter/detector, or similar motion sensing device, in order to bounce a signal 150 off of user 100 which will be reflected and decoded as a position in relation to TDV 200.

Base 160 houses the computational hardware, video interfaces, power supply and software containment device (i.e. RAM or ROM, well known in the art), finally including the user interface, with which user 100 can control visual aspects of the images displayed by TDV 200.

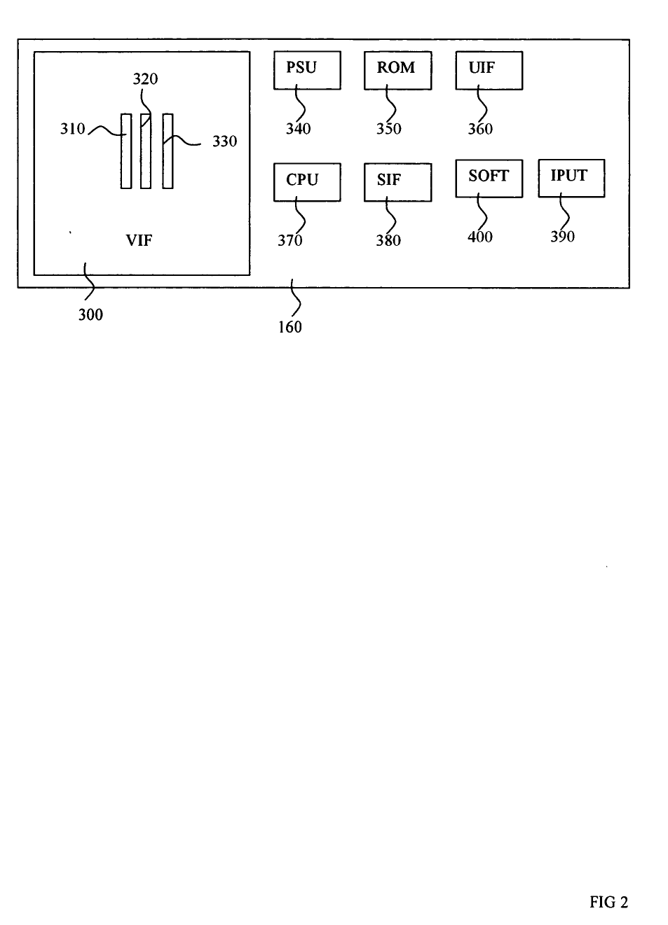

Referring now to FIG. 2, the components of base 160 are shown. Video interface VIF 300 provides a video interface card for each viewing layer. Any video card well known in the art can be used to provide video interface cards 310, 320 and 330 as long as it is compatible with input requirements of whatever is used as a video display unit (VDU), for example a TOLED or VGA monitor or LCD panel, all well known in the art.

PSU 340 supplies power for all components. ROM 350 can be any memory storage device, such as a read only memory or a hard disk. CPU 370 is a micro-processor, required for the computational operations of the present invention. Any of the various CPUs well known in the art could be used as CPU 370.

Sensor interface SIF 380 corresponds to sensor 140 (see FIG. 1) from which input is received so that physical position of user 100 can be determined.

User interface UIF 360 utilizing push buttons, icons and other input/output devices so that user 100 is able to control the invention.

SOFT 400 is software which renders the images across all viewing layers, while simultaneously executing code which relates to UIF 360 in order to allow user 100 to control the 3D viewing apparatus 200.

Video signal input IPUT 390 corresponds to any input compatible with multi-channel transmission and reception. Each of the display layers available in TDV 200 requires its own unique data channel from which it can derive data to display. Therefore, IPUT 390 is required to be able to accept multiple channels of video data simultaneously. IPUT 390 must also feed the data through CPU 370 such that each channel can be rendered on each of the visual layers.

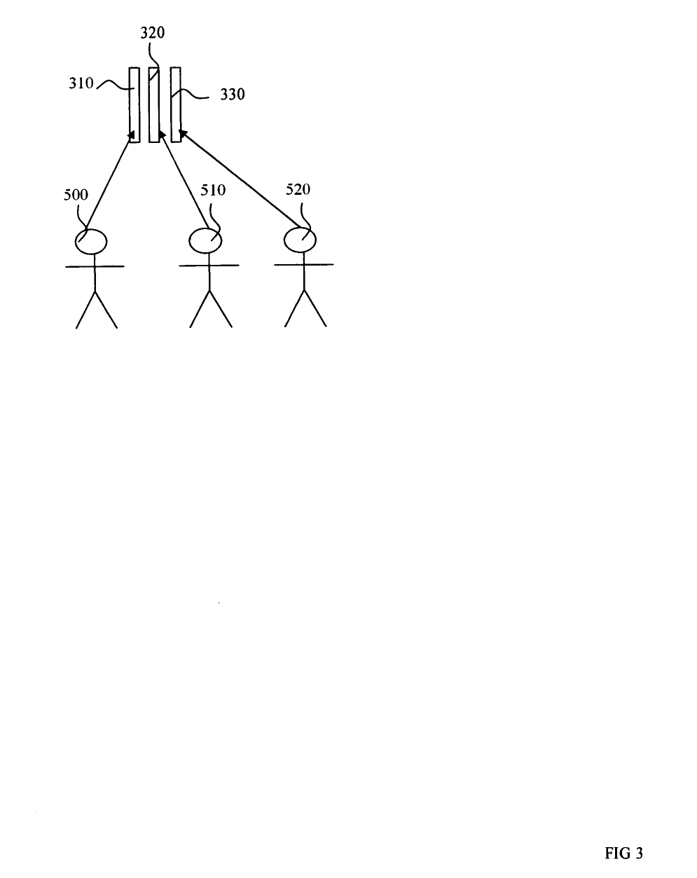

As shown in FIG. 3, the operation of layered display technology (LDT) used in TDV 200 is discussed. Three characters are illustrated, man 500, man 510 and man 520. LDT places each of the three characters on a separate viewing layer. Therefore, man 500 is placed on layer 310, man 510 is placed on layer 320 and man 520 is placed on layer 330. If the user is positioned perpendicular to viewing layers, each character is placed squarely one behind the other, user 100 will only be able to see man 500, as man 510 and man 520 will be obscured from view. If user 100 were to lean to the left or right then the user's new point of view would slightly reveal man 510 and man 520. LDT is an ideal embodiment for video game solutions, as action characters controlled by the game can run and hide behind obstacles. User 100 can alter their point of view by leaning or stepping to provide a better point of view, so that, in a shooting action game, a better point of view is able to reveal the angle at which the target can be hit.

LDT is ideal for video game solutions as all characters in such solutions are controlled and drawn by video game software. Therefore, no complex video recording system needs to be devised in order to capture a scene in three-dimensions.

LDT requires that the viewing layers be placed some distance apart. An example showing how a character would run from the background to the foreground, effectively crossing from the backmost to the foremost viewing layer is now discussed. The video game software would begin by rendering the character small, and in a running style animation. As the character appeared to run forward it would get larger. As it gets larger it will at some point reach a size, where it is suited to moving to the next viewing layer closer to the user, until such time as it reaches the front most viewing layer. Therefore, it can be seen that the video game software needs only slight modification to scale characters in such a way that characters are moved to and from certain viewing layers as suits the game play. LDT is also well suited to low cost three-dimensional multiplayer games, as individual players can adopt a stance which suits their part in the game at any moment. LDT therefore maps very closely to the real word, providing an excellent game playing experience, as players are not required to wear cumbersome hardware in order to see the three-dimensional game view. Multiple players can share points of view and communicate more effectively during game play.

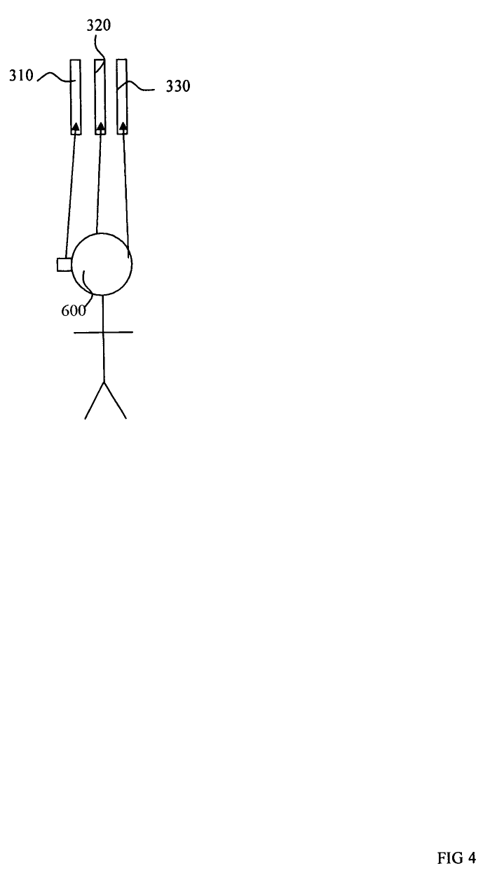

Referring to FIG. 4, another embodiment of the present invention, referred to as Depth Distribution Technology (DDT) is discussed. DDT involves pixels which relate to a single object being distributed over at least one layer. It is possible for a single object to drawn over many viewing layers, using DDT, such that if any viewing layer were removed, the object would be seen as incomplete.

The nose of character 600 is displayed on the foremost viewing layer 310, while the front and middle parts of the face and head are displayed on the middle layer 320. Finally, the back of the head of character 600 is placed on layer 330.

TOLED technology and similar transparent display technologies display the same color whether viewed from the front or rear of the display. Therefore, if user 100 were to walk around RVD 200 as illustrated in FIG. 4, then they would still see a reasonable image of the back of character 600 having the same quality as that available for viewing the front of character 600.

The embodiments as described have used TOLED and similar display technologies without modification. The embodiments of the invention are also suitable for viewing from the front or rear viewing angles.

TOLEDs use flat pixels which emit light in a forward and backwards direction. By modifying the TOLEDs, a flat pixel representation can be effectively a cubic. A cubic pixel (CUXEL) could be viewed from 360 degrees around its Y axis, and 360 degrees around its X axis.

Using CUXELs, an image can be formed in a matrix formed by stacking CUXELS vertically and horizontally, which could be viewed from any angle.

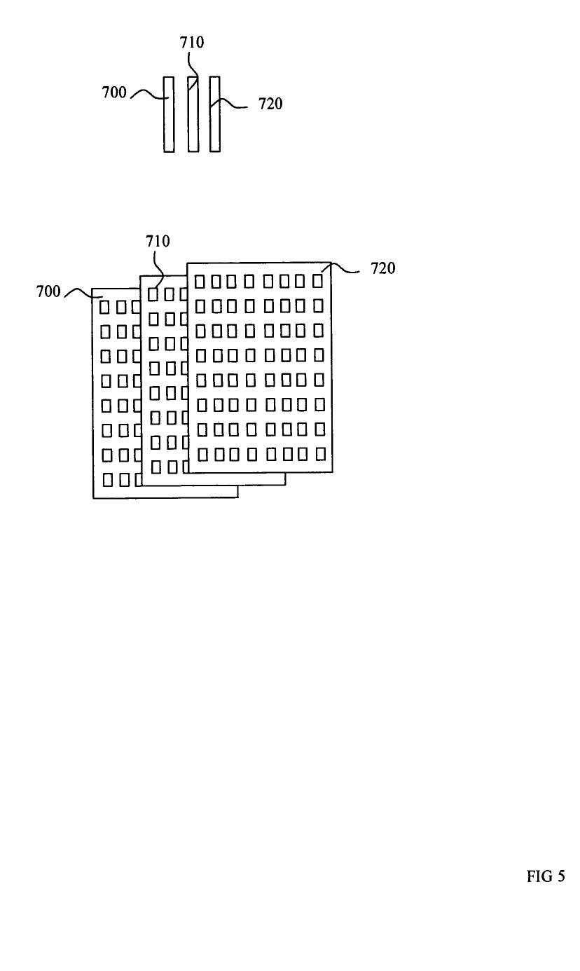

As shown in FIG. 5, a matrix of CUXELs is formed. Each of CUXEL layer 700, CUXEL layer 710 and CUXEL layer 720 are depicted as a 2 dimensional array of CUXELs. The CUXELs are then stacked closely together, in order to form a three-dimensional matrix, that is, a cube of CUXELs is provided.

FIG. 5 depicts a convenient way of thinking about the addressability of each individual CUXEL in the matrix. But, rather than manufacture layers of CUXELs and bond them together, the CUXELs themselves are bound within a single supporting cube, just as all picture elements of TOLEDS are bound together, in a two dimensional matrix which is found in the prior art.

One problem foreseen by constructing CUXELs in a three-dimensional matrix is light emitted by front positioned illuminated CUXELs could be colorized by light emitted by CUXELs behind them. For example, if three CUXELs were horizontally aligned, one being red, one being green and one being blue, then the user may well observe a mix close to a white color, due to the visual mixing of light from three separate CUXELs.

In such a situation, sensor 140, by sensing the physical position of user 100, TVD 200 is able to perform a clipping operation, meaning that all surfaces of all CUXELs not directly in line of sight to user 100 would not be illuminated, ensuring the highest color fidelity available in the art.

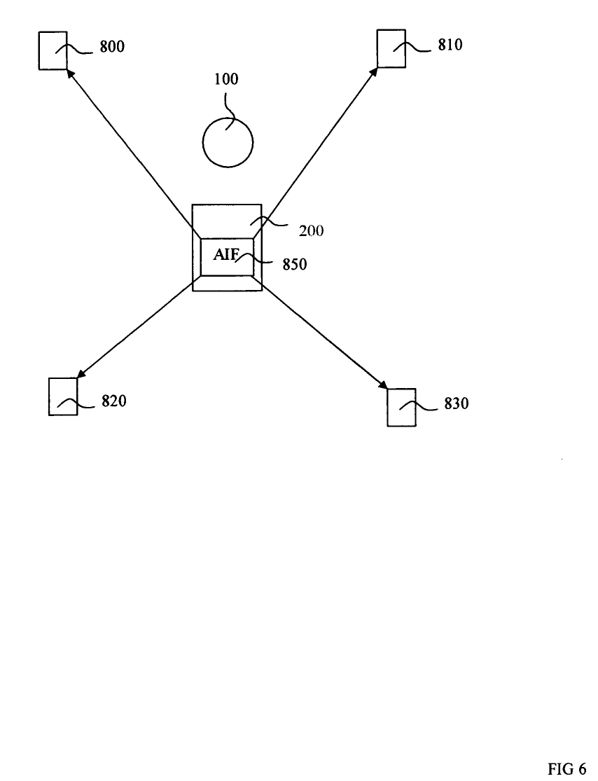

FIG. 6 shows user 100 in an exemplary position in relation to TDV 200. As user 100 moves around TDV 200, sensor 150 is able to assist in locating user 100. Audio interface 850, under the control of CPU 370 is able to then alter the sound coming from the satellite speakers, speaker 800, speaker 810, speaker 820 and speaker 830, typically referred to as surround sound speakers, in order to match the sound to the current viewing position of user 100.

As described earlier, DVD movies contain multi-angle scenes. The present invention can also be viewed from many angles, but as the user changes position, it is necessary to adapt the sound coming from the satellite speakers to match what the user is seeing. For example, when watching a soccer game, moving from the front side of TDV 200 to the rear would be the equivalent of user 100 traveling the equivalent of 200 meters within the soccer stadium to adopt the same viewing position, and as such, would hear a completely different set of sounds. Therefore, sensor 150 (see FIG. 1) allows the invention to sense the position of user 100 to also allow for such changes in soundscape.

When a three-dimensional image is recorded, it is necessary to capture the sound relating to each scene from several positions. It is not necessary to capture sound from infinite locations. The invention will select the sound or image angle closest to any number of preset angles available on from the input source connected to IPUT 390 (see FIG. 1).

The illustrated embodiments of the invention are intended to be illustrative only, recognizing that persons having ordinary skill in the art may construct different forms of the invention that fully fall within the scope of the subject matter appearing in the following claims.

What is claimed is:

1. A three dimensional display apparatus comprising:
a view point having a plurality of pre-set positions, said view point controllable by a user;
at least two stacked display layers, each layer having a different color, wherein each layer is capable of being on or off and can vary in intensity, such that each layer can be bound close together with one another so produce pixels wherein the pixels form a scene which is spread among said at least two stacked display layers to produce a three-dimensional affect.

2. The three dimensional display apparatus of claim 1 wherein said at least two stacked display layers are transparent organic light emitting devices.

3. The three dimensional display apparatus of claim 1 wherein each stacked display layer has at least one color wherein each at least one color is a color selected from the group consisting of cyan, magenta, yellow, black, red, green and blue.
